(19) United States
(12) Patent Application Publication
(10) Pub. No.: US 2025/0200150 A1
(43) Pub. Date: Jun. 19, 2025

(54) IMAGE CLASSIFICATION OF COMMUNICATION CHANNEL FOR IDENTIFYINGSENDER

(71) Applicant: The Regents of the University of Michigan, Ann Arbor, MI (US)

(72) Inventors: Rafi Ud Daula REFAT, Southgate, MI (US); Hafiz M.A. MALIK, West Bloomfield, MI (US)

(21) Appl. No.: 18/981,528

(22) Filed: Dec. 14, 2024

Related U.S. Application Data
(60) Provisional application No. 63/610,403, filed on Dec. 14, 2023.

(51) Int. Cl. G06F 21/30; G01R 29/26; G06T 11/20

(52) U.S. Cl. CPC G06F 21/30; G01R 29/26; G06T 11/206

(57) ABSTRACT

An electronic control unit (ECU) authentication system and method of determining an identity of a sender of a message, where the ECU authentication system is configured to perform the method. The method includes: obtaining distortion data of a data transmission signal sent by a sender over a physical channel through sampling the data transmission signal, wherein the distortion data represents extracted attributes of the data transmission signal as observed over the physical channel; generating distortion image data that represents the distortion data as an image; and identifying a sender of the data transmission signal based on an output generated by a classifier that takes the distortion image data as input.

### GOVERNMENT FUNDING

This invention was made with government support under 2035770 awarded by the National Science Foundation. The government has certain rights in the invention.

### TECHNICAL FIELD

This invention relates to signal transmission sender identification and, more particularly, to identifying senders based on unique, minor variations in transmission signals sent over an electronic data communications bus, network, or other physical channel of a electronic data communications medium.

### BACKGROUND

Certain network communication protocols or implementations, such as controller area network (CAN) based systems, lack authentication in terms of authenticating the sender of the transmission/message. For example, CAN, which is a message-based protocol and is vastly used in the automotive industry due to its ability to construct an inexpensive and faster network, lacks an authentication scheme, making modern vehicles and other devices using CAN open to different kinds of spoofing attacks. There is ample evidence in the literature of taking control of vehicles remotely, which poses a serious threat and can harm passengers and pedestrians. Although several mitigation strategies have been proposed in order to identify the senders, high computational costs have hindered their applicability in practice.

One of the most popular in-vehicle networking protocols, CAN, was first introduced by Robert Bosch™ GmbH in 1983 and became a defacto protocol for in-vehicle communications primarily due to two specific reasons: first, by design, the protocol is applicable for hard real-time environments that guarantee communication with minimal time latency, with “hard” referring to hard limits on message time in that if the message arrival time is over this limit, the message cannot be delivered or accepted by the receiver; and, second, it reduced the wiring problem of a vehicle and was able to reduce the cost of vehicle manufacturing. These reasons are why the CAN bus protocol is used in essentially all modern vehicles as the backbone of in-vehicle network communication.

By default, the CAN protocol is broadcasting in nature, which means messages that are sent to the bus are accessible by all the entities connected to the network. It brings simplicity in terms of design, but on the other hand the simplistic design can be leveraged by hackers, as it lacks a basic security feature (i.e. implementation of a message authentication mechanism which makes it vulnerable to a variety of spoofing attacks). In a single CAN message packet, a field that holds information of the source is absent. Because of the absence of the sender information, any electronic control unit (ECU) on the network can impersonate other ECUs in the network. An adversary can leverage that vulnerability of this protocol to launch various attacks leading to malfunctioning of the vehicle.

For example, in 2015, two individuals remotely took control of a vehicle by injecting CAN data in the network. Surprisingly, the vehicle could not differentiate the impersonating CAN message and moved into a ditch. Another demonstration was shown by the Keen Security Lab of Tencent™ team in 2016 in which researchers remotely controlled a Tesla™ Model S. The researchers have gained entrance remotely by using Wi-Fi/cellular as a back-door and was able to compromise many in-vehicle systems like instrument cluster (IC), central information display (CID), and gateway. Moreover, the team injected a malicious CAN message into the network. In December 2019, a gray-hat hacker created an android application that used an Arduino™ microcontroller in order to inject a CAN message into a Mercedes™ vehicle. The basic functionality of the application was to add features such as locking and unlocking doors, display custom text in instrument cluster, control hazard light etc. This clearly indicates that the researchers took advantage of a known weakness of CAN protocol to spoof the network, namely the absence of source identification field.

To solve the above-mentioned security vulnerability, different approaches have been implemented by the security researchers. These solutions can be broadly categorized into two categories: (1) cryptography based solutions; and (2) intrusion detection system based solution. The traditional cryptography-based solutions can provide some degree of security, but they are computationally expensive and uses the network bandwidth which is critical for CAN based vehicle networks. Moreover, these cryptography based solutions are vulnerable to replay attack. Recently, researchers have proposed intrusion detection system based solutions for detecting CAN cyberattacks by implementing the famous physical layer identification techniques. The fundamental idea of this approach is that the analog signal behaviors of data transmitters has slight variations which are introduced in the design, fabrication and manufacturing process. Researchers show that even manufactured in the same production lot, two same digital devices have unique artifacts in their signaling behavior, which is difficult to control and duplicate. Avatefipour et al. (Avatefipour, O., Hafeez, A., Tayyab, M., & Malik, H. (2017, December). Linking received packet to the transmitter through physical-fingerprinting of controller area network. In 2017 IEEE Workshop on Information Forensics and Security (WIFS) (pp. 1-6). IEEE) was able to extract those unique artifacts and proposed a framework based on neural network for CAN sender identification by utilizing the extracted distortions. Likewise, in the last 5 years, researchers have proposed a lot of frameworks that are effective in CAN transmitter identification.

The proposed transmitted identification method in Avatefipour et al. relies on the fact that each electronic device (e.g., ECU) and channel impulse response of the physical channel (e.g., CAN-Bus) exhibit unique artifacts which can be used for linking received signal to the sending ECU. More specifically, by extracting the distinguishable statistical features of transmitting signals, the source of the coming message is identified.

Let Sᵢ(t) be the output of the it ECU and h/(t) be the impulse response of the j^{th} physical channel between the i^{th} ECU and the physical fingerprinting (PhyFin) unit. The physical signal at the input of the PhyFin unit, yᵢⱼ(t), can be expressed in Equation 1, respectively.

$${y}_{i j} ( t ) = {h}_{j} ( t ) * {S}_{i} ( t ) where , * denotes convolution operator \qquad Equation ( 1 )$$

Physical signal at the input of PhyFin unit, yᵢⱼ(t) is used for linking the signal to its source.

Although the proposed method in Avatefipour et al. works well for sender/transmitter identification, the processing costs are high, making real-time sender identification challenging.

### SUMMARY

In accordance with a first aspect of the invention, there is provided a method of determining an identity of a sender of a message. The method includes: obtaining distortion data of a data transmission signal sent by a sender over a physical channel through sampling the data transmission signal, wherein the distortion data represents extracted attributes of the data transmission signal as observed over the physical channel; generating distortion image data that represents the distortion data as an image; and identifying a sender of the data transmission signal based on an output generated by a classifier that takes the distortion image data as input.

The method of the first aspect may further include any of the following features or any technically-feasible combination of two or more of the following features:
the image is a two-dimensional image represented by a matrix of data values each representing a pixel of the image;
the image is a recurrence plot generated based on the distortion data;
the distortion data is voltage time-series data;
the recurrence plot is generated by: comparing a recurrence threshold to a difference between a first voltage time-series data value and a second voltage time-series data value; and determining a pixel value of the recurrence plot based on whether the difference exceeded the recurrence threshold;
the classifier is or includes a convolutional neural network (CNN) that performs convolution operations on the image;
the classifier is trained using noisy image training data, and wherein the noisy image training data includes one or more noisy images;
each noisy image of the one or more noisy images is generated by introducing noise into the distortion data to obtain noisy distortion data and then generating the noisy image through transforming the noisy distortion data into an image;
transforming the distortion data into an image is performed by generating a recurrence plot based on the noisy distortion data;
the distortion data represents a difference between observed measurements in the data transmission signal and expected values;
the extracted attributes of the data transmission signal are used for generating the distortion image data;
the distortion image data includes at least one pixel value determined by: determining a voltage value for the data transmission signal, and comparing the voltage value for the data transmission signal to a target voltage;
the target voltage is greater than 0.5 Volts and less than or equal to 5 Volts;
the data transmission signal is formed as a series of voltage differentials relative to one or more predefined voltage levels, and wherein the target voltage is a voltage of one of the predefined voltage levels;
each of the one or more predefined voltage levels is associated with a discrete state used for indicating a value of a message being communicated in accordance with the physical channel;
the one or more predefined voltage levels is a plurality of predefined voltage levels, and wherein the target voltage is selected as one of the plurality of predefined voltage levels based on the discrete state; and/or
the discrete state corresponds either to a recessive state indicating a recessive bit as the value of the message being communicated or to a dominant state indicating a dominant bit as the value of the message being communicated.

According to a second aspect of the invention, there is provided an electronic control unit (ECU) authentication system for authenticating transmission signals carrying data over a communications network. The ECU authentication system includes: a first ECU having at least one processor and memory storing computer instructions; a second ECU; and a communications network for providing a physical channel for carrying a data transmission signal from the second ECU to the first ECU. The ECU authentication system is configured, as a result of executing the computer instructions using the at least one processor, to: obtain distortion data of a data transmission signal sent by the second ECU over the physical channel of the communications network, wherein the distortion data is obtained through sampling the data transmission signal; generate distortion image data that represents the distortion data as an image; and identify a sender of the data transmission signal based on an output generated by a classifier that takes the distortion image data as input.

The ECU authentication system of the second aspect may further include any of the following features or any technically-feasible combination of two or more of the following features discussed above in connection with the method of the first aspect.

### BRIEF DESCRIPTION OF THE DRAWINGS

Illustrative embodiments will hereinafter be described in conjunction with the appended drawings, wherein:

FIG. 1 is a block diagram depicting an electronic communications system having a sender, receiver, and an ECU authentication system, according to one embodiment;

FIGS. 2A-C depict is a schematic diagram of an exemplary controller area network (CAN) based communications system having three ECUs, and demonstrating a spoofing attack, according to one embodiment;

FIG. 3 is a flowchart illustrating a method of determining an identity of a sender of a message, according to one embodiment;

FIG. 4 is a voltage time-series graph illustrating two data transmission signals, according to one embodiment;

FIG. 5 is a voltage time-series graph illustrating a data transmission signal and an ideal or target CAN-H signal, according to one embodiment;

FIG. 6 depicts exemplary recurrence plots, specifically sixteen recurrence plots, according to one embodiment;

FIG. 7 shows exemplary distorted images that are generated from different level of noisy voltages, according to one embodiment;

FIG. 8 is a block diagram depicting a sender identification system that implements the method of FIG. 3, according to one embodiment; and

FIG. 9 includes graphs illustrating physical layer orientation of the OSI model for CAN protocol signaling.

### DETAILED DESCRIPTION

The system and method described herein enables identifying a sender of a data transmission signal through extracting distortion data from the data transmission signal. The distortion data (or extracted distortion data) is data representing values derived from samples of the data transmission signal, which is an analog signal, and the distortion data is separate than the data encoded within the data transmission signal. Namely, at least in embodiments, the distortion data is data indicative of signal variances relative to a target signal path, such as variances in voltage relative to a target voltage. The distortion data is used to identify and verify the authenticity of the data transmission signal through generating a signature and comparing the signature to a predetermined signature for the ECU, which may be determined and stored at the system ahead of time, at least according to some embodiments.

According to embodiments, the distortion data is converted, modified, transformed, or otherwise used to generate an image, represented by a matrix of data values each constituting a pixel of the image. In embodiments, the image is a recurrence plot generated based on the distortion data, which may be voltage time-series data, as mentioned above. In one embodiment, this voltage time-series data is used to generate pixel values of the recurrence plot based on, for example, comparing a recurrence threshold to a difference between a first voltage time-series data value and a second voltage time-series data value; here, a pixel value of the recurrence plot is determined based on whether the difference exceeded the recurrence threshold, such as a 0 or 1 value. In other embodiments, a continuous or non-discrete value may be used.

Once the image is generated, the image is classified by a classifier, such as a machine learning (ML) based classifier. In embodiments, the ML-based classifier is one having a convolutional neural network (CNN), referred to as a CNN classifier, and this CNN classifier may take the image data as input and generate an output that is indicative of a particular sender of the data transmission signal. In embodiments, the CNN classifier includes representative or template data for each of the potential senders, and this template data is used for classification of the data transmission signal. In other embodiments, the CNN classifier is trained using custom training data that includes one or more representative images for each of the plurality of senders/transmitters.

Below, there is provided an embodiment in which data transmission signals are transmitted using a controller area network (CAN) bus that uses an analog signal (the data transmission signal) to generate dominant and recessive bits in order to convey information. Background of CAN is presented below in order to facilitate illustration of the method and system provided herein, at least according to embodiments, particularly CAN-based embodiments.

To highlight the overview of CAN protocol, the protocol characteristics and its representation in terms of Open Systems Inter-connection model (OSI model) is described here. Moreover, the security issues originated from the basic architectural design of the protocol is described below.

By design the controller area network (CAN) is a broadcasting protocol where ECUs communicate with each other using a single wire. This enables the system manufacturer to reduce complex wiring design of many point to point connections between ECUs and make the system easily maintainable. While connected to a standard CAN network, an ECU can send 0-8 bytes of data with an eleven bit identifier. The identifier is used for the priority scheme of CAN protocol which is that messages with lower arbitration ID have high priority while going through the bus. On the other hand, any entity connected to the bus can listen to all the traffic in the network for its broadcasting nature.

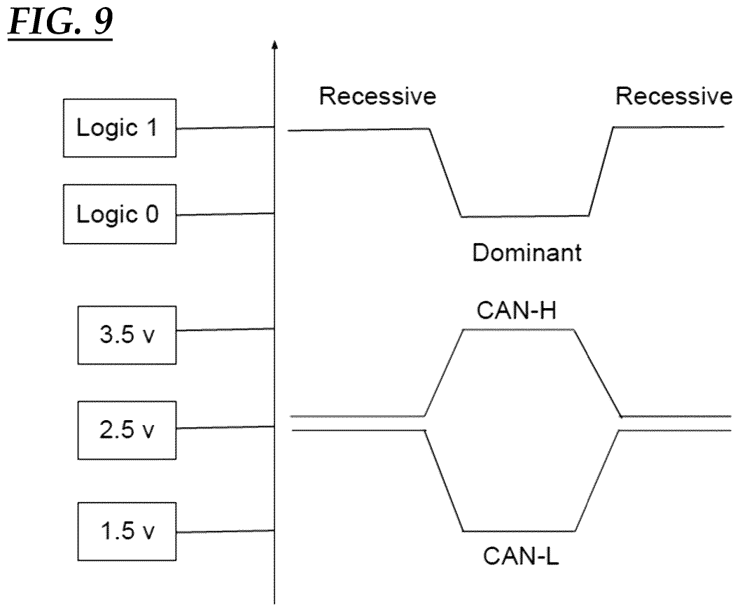

The CAN protocol is specified in International Organization for Standardization (ISO) 11898 and is defined in the physical layer and data link layer of the Open Systems Interconnection (OSI) model. In the CAN physical layer, the data is handled as binary bits and the core functionality of this layer is to ensure bit encoding/decoding, bit synchronization and indicate physical wire orientation and on the other hand, CAN data link layer handles CAN data as frames and performs complex tasks like data encapsulation, frame encoding, frame error detection. Physically, the CAN bus is actually a twisted pair wire, terminated with 120 ohm. The twisted pair is called the CAN high (CAN-H) and the CAN low (CAN-L) and provides protection against electromagnetic interference. The CAN-H is an example of a first discrete state indicating a value of a message, such as a discrete state indicating a recessive or dominant bit. The CAN-L is another example of a discrete state different than the CAN-H state. In terms of physical layer orientation of OSI model, CAN protocol follows differential signaling (shown in FIG. 9) where the final voltage of a single bit data is extracted by subtraction between CAN-H and CAN-L. When there is a 0 bit in the bus (dominant bit), CAN-H pulls 3.5 V where CAN-L contains 1.5 V. In terms of a bit with value 1 (recessive), CAN-H and CAN-L both set the voltage to 2.5 V.

In data link layer, a CAN protocol handles data as frames. By default a standard CAN packet has 108 bits in total as shown in Table 1. It starts with a single bit of data called start of frame (SOF) field. Then it is followed by 11 bit arbitration ID (AID), 1 bit remote transmission request (RTR), 6 bit control field, 0-64 bits of data field, 16 bits cyclic redundancy check (CRC), 2 bits acknowledgment (ACK) field, 7 bits of end of frame (EOF) field. While connected in a communications network, an ECU can send a CAN packet to the traffic by sending a CAN data frame by putting dominant bit in the RTR field and an ECU can request data from another ECU by sending a CAN remote frame with a recessive bit in the RTR field. Although there is an AID field presented in a CAN packet, there is not a single field available that indicates the source address. There is CRC field in a CAN packet which only protects the data field. So, the absence of source field and the broadcasting nature of the protocol clearly indicates that the CAN protocol lacks one of the concepts of the famous CIA triad (confidentiality, integrity, and availability). According to embodiments, the system and method operate to identify senders thus ensuring integrity.

TABLE 1
A standard CAN data packet

| Field name | Number of bits |
|---|---|
| Start of frame | 1 |
| Arbitration ID | 11 |
| Remote transmission request | 1 |
| Control fields | 6 |
| Data field | 0-64 |
| Cyclic redundancy check (CRC) | 16 |
| Acknowledgement | 2 |
| End of frame | 7 |
| Total | 108 |

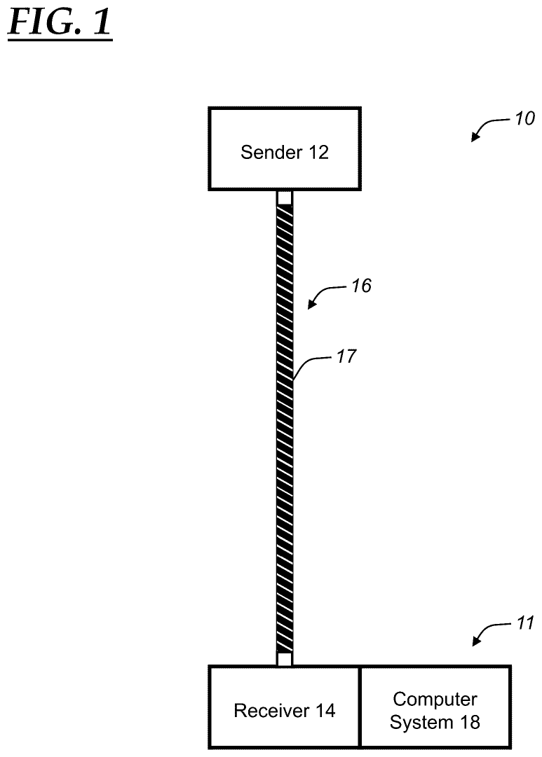

With reference to FIG. 1, there is shown an embodiment of an electronic communications system 10, which includes a sender or transmitter electronic control unit (ECU) (or “sender”) 12, a receiver ECU (or “receiver”) 14, a communications network 16 over which data transmission signals are transmitted from the sender 12 to the receiver 14, and a computer system 18. In the present embodiment, the communications network 16 is illustrated as including a physical channel implemented as a CAN bus 17 implemented via twisted pair wiring, as illustrated in FIG. 1. The receiver 14 and the computer system 18 are used to identify the sender of data transmission signals sent over the communications network 16 and, together, the receiver 14 and the computer system 18 may be referred to as an ECU authentication system 11. The ECU authentication system 11 is shown in the illustrated embodiment as being located at and directly (i.e., via wire, bus, like hardware, or dedicated wireless channel therebetween) connected to the receiver 14. The ECU authentication system 11 executes the method described herein in order to identify the sender of a data transmission signal sent over the communications network 16, and this functionality may be effected by executing the computer instructions, so configured to perform the method as described herein, in order to process the data transmission signal to identify the sender. In embodiments, one or more instances of an ECU authentication computer program are used (ECU authentication instance) for identifying a sender for each (or at least a set) of data transmission signals received at the receiver 14. However, it will be appreciated that the ECU authentication system 11 may include components located remotely from the receiver 14, such as a secondary computer system for supporting the ECU authentication system 11 (e.g., providing updated parameters for the method or other processing).

The sender 12 is an ECU that transmits data transmission signals to the receiver 14, and these data transmission signals may be received at the receiver 14. The receiver 14 may then process the data transmission signals in order to identify the sender 12 of the data transmission signals. The identity of the sender of the data transmission signal can be used to ensure that the received message (as encoded in the data transmission signal) is authentic and not a part of a spoofing attack, for example. The sender 12 may also receive data transmission signals via the communications network 16, effectively operating also as a receiver. Likewise, receiver 14 may also send or transmit data transmission signals via the communications network 16, effectively operating also as a sender. Furthermore, any number of other ECUs may participate in the communications network as a sender and/or receiver, according to embodiments.

In embodiments, the sender 12 includes a microcontroller or a dedicated controller, such as the MCP2515 from Microchip Technology™, which is a dedicated CAN controller. This element governs the CAN protocol, ensuring both the sending and receiving of CAN frames are executed properly. The sender 12 may include a transceiver, which operates to transmit data transmission signals over a communications medium, such as a CAN bus, which may be hardwired and the physical bus. The TJA1050 from NXP Semiconductors™ is a notable example of this transceiver. It has the dual role of transforming digital messages from the controller into differential voltage signals suited for the CAN bus and doing the reverse as well. Augmenting these components is the oscillator or crystal, which furnishes a clock source vital for the system's timing and synchronization. Given that the CAN protocol demands impeccable timing for activities like bit sampling and error detection, the inclusion of such an oscillator becomes indispensable for the seamless function of the ECU.

The receiver 14 is an ECU that receives data transmission signals from the sender 12, and potentially from other ECUs participating in the communications network 16. In embodiments, the communications network 16 is a CAN-based communications network, which is a communications network that uses CAN to facilitate communication between various components, such as sensors, actuators, and control modules, within systems like, but not limited to, various vehicle systems, such as a vehicle's braking system, engine management, airbag deployment, and infotainment, among other applications. In embodiments using a CAN-based communications network, the sender 12 and the receiver 14 are connected via a CAN bus over which data transmission signals are transmitted. The CAN-based communications network may use any of a variety of different CAN bus variants, including High-Speed CAN, Low-Speed/Fault-Tolerant CAN, and CAN FD, for example, may be used for the CAN bus 17. Also, in CAN-based implementations, the physical layer utilizes differential signaling via CAN-H and CAN-L lines, typically transmitted over shielded or unshielded twisted pair wires. In other embodiments, the communications network 16 may be implemented using other protocols or technologies, such as LIN (Local Interconnect Network). LIN also often serves as a communication protocol for automotive systems and, like CAN, LIN uses voltage levels for encoding, although it typically operates at a lower data rate and is often used for simpler, non-critical applications within the vehicle, such as window controls or ambient lighting.

The computer system 18 is used to perform a process or method in order to identify a sender of a data transmission signal, and this process may be repeated any desired number of times, such as for each message transmitted over the communications network 16, for example. The computer system 18 includes at least one processor and memory storing computer instructions that, when executed by the at least one processor, cause the computer system 18 to perform the method described herein, such as in order to identify the sender of each of the data transmission signals transmitted over the communications network 16. The computer system 18 is shown as being local to the receiver 14, as the computer system 18 uses the data transmission signal to identify the sender. In embodiments, the computer system 18 may be integrated into a controller of the receiver 14, such as a CAN controller.

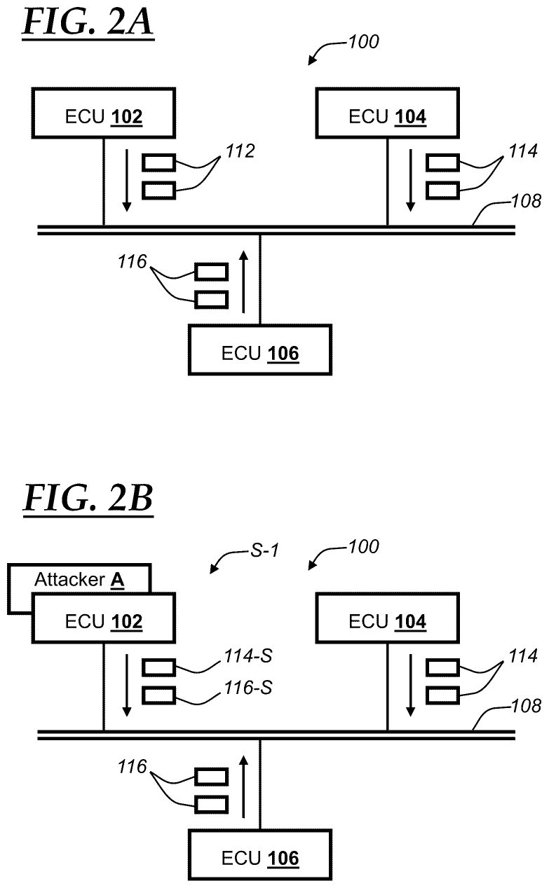

With reference to FIGS. 2A-C, consider a CAN network 100 having three ECUs 100, 102, 104, as reference in the following discussion is made to these figures for purposes of demonstrating a spoofing attack. As mentioned above, due to the absence of sender or receiver address as discussed above, CAN network is susceptible to spoofing attack. The attack can be defined as when a compromised ECU tries to send CAN data by impersonating an authorized ECU with the same or different CAN AID. In a modern vehicle, this can happen two different ways: one way is when an attacker takes control of an authorized ECU utilizing its code vulnerabilities whereby the compromised ECU is able to impersonate any other ECU connected to the network; and the other way is when an attacker gains access to the vehicle by external connectivity (e.g. via onboard diagnostic II (OBD-II) port or using Wi-Fi™ or Bluetooth™). It is a feasible attack example because having OBD-II ports included in the vehicle is a standard in the automotive industry, with pin “6” (the sixth pin) and pin “14” (the fourteenth pin) representing the CAN interface that can be used to connect external devices.

FIG. 2A depicts a computer system 100 with three ECUs 102, 104, 106 that are each communicatively coupled via the communications network 108, which is analogous to the communications system 16 discussed above. Further, each of the three ECUs 102, 104, 106 may be a sender, a receiver, or both, as the discussion of the sender 12 and the receiver 14 is analogous to the ECUs 102, 104, 106 when being used in such a capacity (as sender, receiver, or both). Each of the ECUs 102, 104, 106 is shown as transmitting data packets 112,114,116 in the form of a data transmission signal, such as through using a CAN-based communications network for the network 108.

FIG. 2B depicts the computer system 100 of FIG. 2A, under a first spoofing scenario S-1 where an attacker A carries out a spoofing attack in which the attacker A takes control of ECU 102 and is trying to spoof/impersonate ECUs 104, 106 through issuing spoofed messages 114-S, 116-S, corresponding to a spoofed message of the second ECU 104 and third ECU 106, respectively.

FIG. 2C depicts the computer system 100 of FIG. 2A, under a second spoofing scenario S-2 where an attacker A carries out a spoofing attack in which the attacker A gains access to the communications network (e.g., the CAN bus) as an external entity that impersonates the second and third ECUs 104 and 106 through issuing spoofed messages 114-S′, 116-S′, corresponding to a spoofed message of the second ECU 104 and third ECU 106, respectively. The spoofed messages 114-S, 114-S′, 116-S, 116-S′ may have an arbitration id and data payload that impersonates the ECU 104, 106.

To help ensure integrity in the CAN bus, one approach is to implement message authentication scheme by including a message authentication code (MAC) inside CAN frame. While it makes the CAN bus secure but according to the standards, the least size of the MAC is 64 bit to prevent collisions. So, the challenge of implementing the MAC based approaches is to add 64 bit MAC along with the data that needs to be transported to the network where the data field can only hold up to 64 bits of data 1. To overcome the approach, researchers proposed two kind of MAC implementations: one is, instead of using 64 bit MAC, using a truncated MAC to include integrity to CAN protocol; and the other approach is to use CAN+ protocol, an improvement of the existing CAN where additional data can be sent in time intervals to authenticate CAN messages. For example, researchers in crafted a 4 byte MAC and put it into the data field of the CAN packet to authenticate CAN message. The disadvantage of truncating CAN data field to include MAC is it limits the size of data payload to be transmitted in a CAN packet and restricts the CAN protocol to transmit 8 bytes data payload. The proposed works send two CAN messages where one contains the data payload the other one contains the MAC address. The approach resolves the issues originated by the truncated MAC approaches but it uses the limited traffic bandwidth of CAN network (1 Mbit/s) as it needs to send two packets of data to securely send a single CAN data payload.

Apart from the CAN message authentication techniques, researchers have considered to fingerprint CAN senders by using physical unclonable characteristics such as clock skews and voltage. The main idea of this approach is to identify the source of CAN transmitters. The concept is adopted from the famous physical layer identification (PLI) technique where the unique characteristics of transmitters are extracted to link the physical signals to the senders. The techniques for CAN PLI can be classified into two categories: clock skew based fingerprinting; and voltage based fingerprinting.

Clock skew based fingerprinting: The quartz crystal clock determines the different clock frequencies on an ECU, resulting in random clock drifts which can be used to uniquely identify an ECU. Cho and Shin proposed a Clock-based IDS (CIDS) which exploits the intervals of periodic message to estimate the clock skews as the fingerprint of the transmitter ECU. The idea was used to estimate clock behaviors of ECUs to detect the intrusion and identify the source of the message. However, this method is effective in a temperature-stable environment.

Voltage-based fingerprinting: Authenticating the CAN message transmitter based on the unique and immutable physical characteristics such as the voltage, is termed as physical fingerprinting. Researchers in Avatefipour et al. extracted time domain and frequency domain statistical features using voltages captured from the ECUs and proposed a neural network-based ECU classifier, and achieved an accuracy of 98.3% on an experimental setup using microcontrollers. Others have proposed an edge-based identification method using voltage collected using picoscope (software defined oscilloscope) and a naive Bayesian classifier. As a feature they used statistical time domain features such as mean, variance, skewness, kurtosis, radio max plateau, plateau, overshoot height, irregularity, centroid, flatness, power and maximum. Similar work has been proposed that uses 10 time domain features and 10 frequency domain features and achieved an accuracy of 98.94% accuracy at maximum while voltage data is collected using an oscilloscope at a sampling rate of 2 GS/s. Bellaire et al. (Bellaire, S., Bayer, M., Hafeez, A., Refat, R. U. D., & Malik, H. (2023). Fingerprinting ECUs to Implement Vehicular Security for Passenger Safety Using Machine Learning Techniques.

The research works described above achieved high accuracy in identifying CAN signal senders, but the feature extraction is highly expensive in terms of computational complexity. Table 2 represents the common statistical features and their corresponding computational cost. To overcome this, the system and method herein, at least according to some embodiments, eliminates the necessity of extracting highly computational statistical features described above by utilizing images generated from the uniqueness presented in the voltage data to identify CAN signal transmitter. The image is generated using recurrence plot method whose computational complexity is Θ(n²) whereas the computational complexity of any framework that uses feature shown in Table 2, is 3*(Θ(n²)+Θ(n)). Experimental results show that the proposed framework processes features to identify ECUs with a lower computational time than the state-of-the-art work.

TABLE 2
Computational complexity of common state-of-the-art statistical features

| Feature Name | Equation | Time complexity |
|---|---|---|
| Minimum | min = min(xᵢ) | Θ(n) |
| Maximum | max = max(xᵢ) | Θ(n) |
| Mean | $\overline{x} = \frac{{\sum }_{i = 1}^{n} {x}_{i}}{n} = \frac{{x}_{1} + {x}_{2} + … + {x}_{n}}{n}$ | Θ(n) |
| Variance | ${s}^{2} = \frac{{\sum }_{i = 1}^{n} {( {x}_{i} - \overline{x} )}^{2}}{n - 1} = \frac{{\sum }_{i = 1}^{n} {x}_{i}^{2} - n {\overline{x}}^{2}}{n - 1}$ | Θ(n²) |
| Skewness | $skewness = \frac{{\sum }_{i = 1}^{n} {( {x}_{i} - \overline{x} )}^{3}}{( n - 1 ) * {σ}^{3}}$ | Θ(n²) |
| Kurtosis | $kurtosis = \frac{{μ}_{4}}{{σ}^{4}}$ | Θ(n²) |

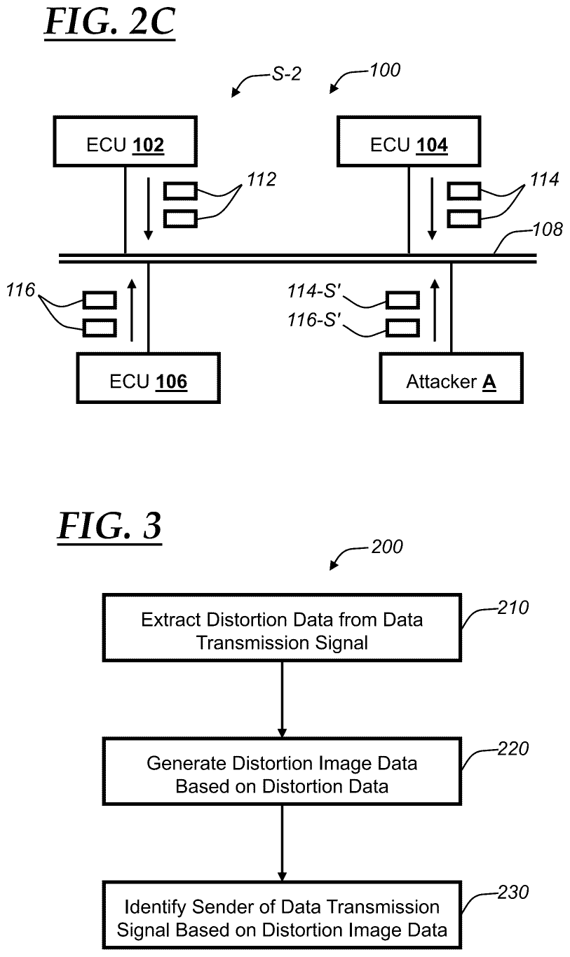

With reference to FIG. 3, there is shown a method 200 of determining an identity of a sender of a message. The method 200 is performed by the computer system ECU authentication system 11, particularly the computer system 18, at least in embodiments.

The method 200 begins when a data transmission signal is received. The data transmission signal is an analog signal that is used to encode data, such as for conveying messages or information. In embodiments, the data transmission signal is formed as a series of voltage differentials relative to one or more predefined voltage levels, such as the three CAN levels (1.5 V, 2.5 V, 3.5 V) discussed above.

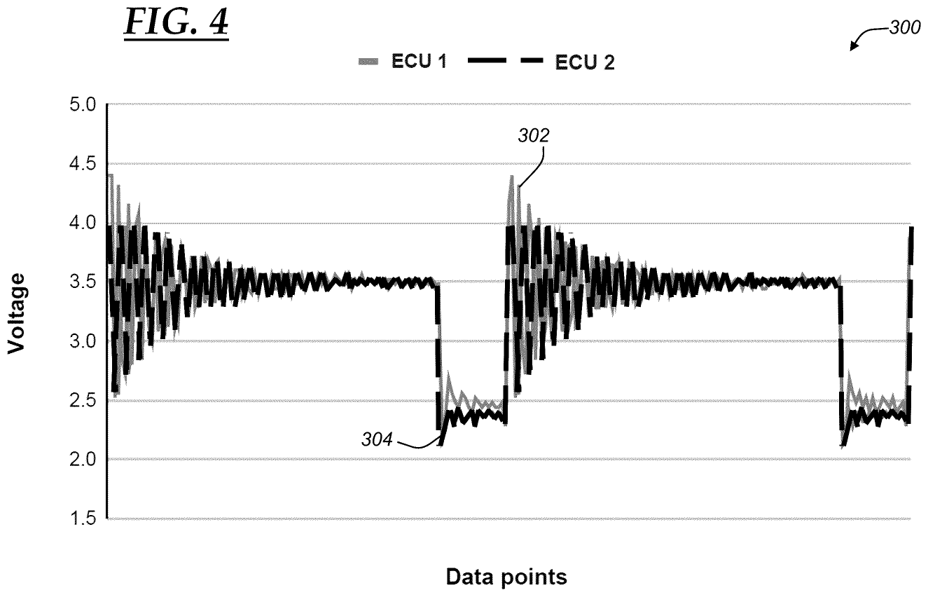

FIG. 4 is a voltage time-series graph 300 illustrating two data transmission signals 302, 304, each one being from a different ECU, such as ECU 102 and ECU 104. The voltage time-series graph 300 depicts voltage measurements taken over a period of time (labelled “Data points” in FIG. 4). As shown, this graph 300 illustrates inherent variations in voltage, which may be introduced in the design, fabrication, and manufacturing process, and this is true even with two of the same devices having all of the same specifications and made at the same facility. Although using aspects of the physical layer have been used for identification of senders in connected networks for many years, this approach exploits sight variations in its output analog signal (referred to as data transmission signal) for identification of the sender, and further implements selective sampling of the data transmission signal, which is discussed below.

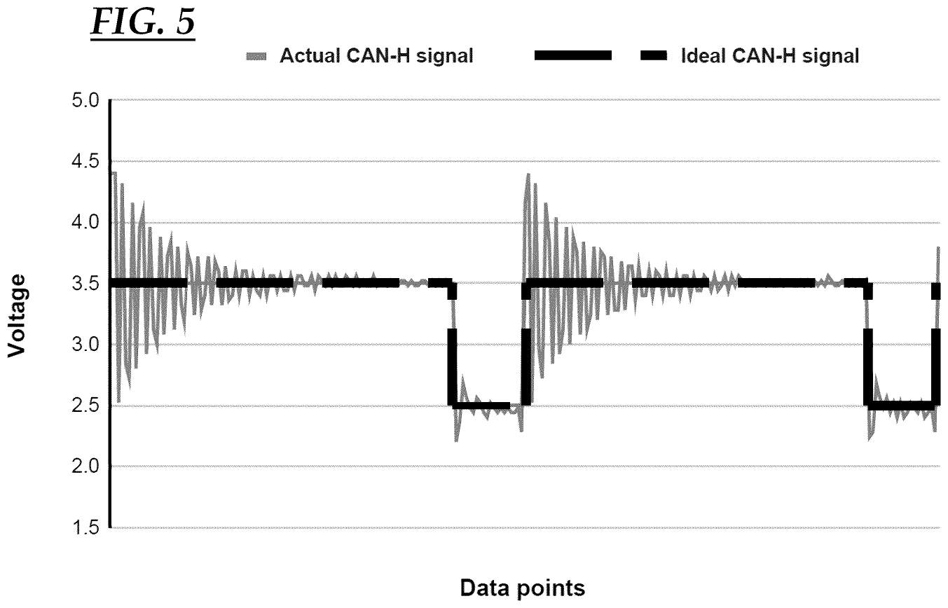

The above-mentioned inherent variation of the CAN transmitter is used to fingerprint the transmitter, as it is unique. FIG. 5 shows how a CAN signal stays in an ideal condition and how it distorts in the real world. The spikes from the ideal line is considered as an impurity or distortion of each CAN transmitter. According to embodiments, the system and method uses such impurities or distortions to create a unique signal characteristic profiling for each transmitter and this may be referred to as the “signature”.

Below is a discussion on how to extract the distortions of the analog signal. It is assumed V is a collection of analog voltage signal captured from the CAN-H wire where:

$$V = ( {V}_{1} , {V}_{2} , {V}_{3} … {V}_{n} ) \qquad Equation ( 1 )$$

Vᵢ should be 3.5 when it is a dominant bit and 2.5 when it is a recessive bit. In real world, the unique artifacts add noise to the ideal value and creates spikes (see FIG. 5). In order to extract the unique variations, the spiking points needs to be subtracted from 3.5 or 2.5 depending on it is a dominant or recessive bit. So, the unique artifacts (Distortions, Dᵢ) of an ECU is:

$${D}_{i} = ( {V}_{i} - {T}_{j} ) \qquad Equation ( 2 )$$

where Tⱼ is either 3.5 or 2.5 depending on if the bit is dominant or recessive.

With reference back to FIG. 3, the method 200 begins with step 210, wherein distortion data is generated based on the data transmission signal. The distortion data is data indicative of signal variances relative to a target signal path, such as variances in voltage relative to a target voltage when taken over time (see voltage time-series graph 300 of FIG. 4). The distortion data is thus data extracted from the data transmission signal, and this data may be used to identify a sender. The method 200 continues to step 220.

In step 220, distortion image data is generated based on representing the distortion data as an image. In one embodiment, a recurrence plot is used to represent the distortion data. A recurrence plot (or “RP”) is a tool commonly used in data analysis to visually and quantitatively examine the temporal behavior of complex systems, often represented through time series data. An RP is created by plotting a two-dimensional square matrix where each axis represents the time series. The pixel values in the plot are determined based on the recurrence of a state at different times, with each pixel (i, j) colored or shaded to indicate the closeness or similarity between the states at times i and j according to a predefined threshold. This similarity is typically assessed using a distance metric, such as Euclidean distance, where pixels are marked if the distance between the states at two different times is less than this threshold, revealing patterns, structures, and recurring behaviors in the time series data. In embodiments, the pixel value may be discrete (1 or 0) or may be a continuous or more precise value, such as a difference between voltage readings, which may be a number with three or four significant digits, for example.

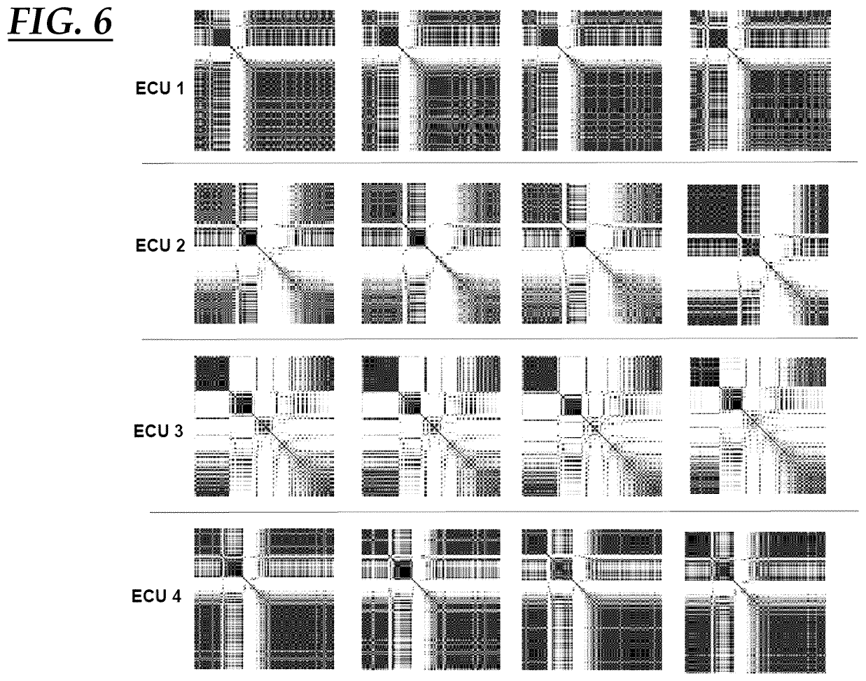

With reference to FIG. 6, there are shown examples of recurrence plots, specifically sixteen recurrence plots are shown, four for each of four ECUs, which are shown as labeled “ECU 1”, “ECU 2”, “ECU 3”, and “ECU 4” in FIG. 6. As clearly seen in FIG. 6, the four recurrence plots of “ECU 1” share commonalities in pixel values, and an observer would match or group these four recurrence plots with or to one another; the same is true for the recurrence plots of the other three ECUs shown in FIG. 6. This principle is used for the classification that is performed in step 230.

With reference back to FIG. 3, the method 200 continues to step 220, wherein a sender of the data transmission signal is identified based on the image, such as based on an output generated by a classifier that takes the distortion image data as input. According to embodiments, an ECU (or sender) is uniquely identifiable through recurring patterns in signals the ECU transmits, which may be visualized using recurrence plots as shown in FIG. 6. According to embodiments, techniques that consider the problem as an image classification problem may be used in order to generate a sender signature, which is information that is generated based on the extracted distortion data and that uniquely identifies the sender.

As discussed in the background, while conventional sender identification frameworks offer high percentage of accuracy, the core architecture of these methods depend on handcrafted feature engineering and is computationally costly. As such approaches rely on neural network based methods, the feature engineering remains an essential step in testing phase of the framework. In some cases, the feature engineering becomes computationally so expensive, that the real time sender identification remains a challenge. Additionally, a significant amount of data is required for training neural networks, and obtaining sufficient data poses a challenge for automotive platforms with limited resources. Therefore, the high cost of feature engineering and the limited availability of training data, specifically physical voltage signals, are the primary factors hindering the application of deep learning in physical fingerprinting research for in-vehicle automotive purposes. Hence, at least according to embodiments, the system and method aims to identify the sender of the CAN message using a computationally-affordable approach that employs deep neural networks.

The goal of this subsection was to create recurrence plot by using distortions captured from the CAN transmitters and visualize them in human eyes. To perform that experiment we collected analog signals from 4 ECUs using the testbed described in subsection A and extracted the distortions of the ECUs. The distortions are mapped to create recurrence plot and saved as images for visualization. Each image was generated from 96 voltage data points (length of CAN-H dominant bit) started from the peak of the voltage signals. FIG. 6 shows the generated plots of 4 ECUs where each row has images for each ECU. It indicates that, the images has their own patterns and they are different to each other visually.

Visually, RPs provide some useful insights about the sender ECUs. But the question arises how much information the RPs contain to distinguish the CAN transmitters. In order to do so, an experiment was deigned to quantify the RPs generated from the CAN ECU signals. To achieve that, a recurrence quantification analysis was performed to quantify the RPs by extracting recurrence properties from the generated RPs. Recurrence parameters, such as recurrence rate, entropy diagonal lines, longest diagonal line length, laminarity, divergence, additional diagonal line length to perform data analysis, were used. To do so, a Python program is written to generate RPs from CAN high analog voltages collected from 8 ECUs and then the images are used to perform recurrence quantification analysis (RQA) in an Apple M1 chip computer with 8 GB RAM. For RQA, the images are fed into python library PyRQA and the parameters are extracted for rigorous analysis. To see the feature differences of the ECUs in terms of RQ parameters the data was plotted in a box plot, which showed that the 8 ECUs have notable variations when compared against the 6 recurrence parameters.

In embodiments, the plurality of senders each have a representative distortion image that is used for the classification/matching. According to embodiments, classifying an image by matching it to one of multiple predetermined template images using a CNN is performed by using convolutional layers to apply various filters to the input image in order to generate feature maps or other feature data, emphasizing distinct attributes of the image. For the task of matching and classifying an image against a set of predefined template images (referred to as “representative distortion images”), CNNs may be utilized to generate high-dimensional embeddings or feature vectors for each image. These embeddings serve as compact numerical representations of the images' key features and may serve or act as a signature or fingerprint. The classification is enabled by comparing the embedding of the new image with those of the template images. This comparison typically employs distance metrics like Euclidean distance or cosine similarity to quantify the similarity between the new image's feature vector and those of the templates. Advanced CNN architectures such as ResNet, Inception, and VGG may be used, particularly because of for their deep layering and efficient feature extraction capabilities. Also, in embodiments, transfer learning may be used, such as where models pre-trained on large datasets, like ImageNet, are adapted and fine-tuned with the specific set of template images to enhance accuracy in the targeted classification task. Dimensionality reduction techniques, such as Principal Component Analysis (PCA), may be applied to streamline the embedding comparison process.

Data augmentation plays a vital role in enriching the training data, introducing variations that may occur, such as those introduced via environmental factors. To accommodate for this, the classifier may be trained using noisy image training data, which includes one or more noisy images. Augmenting the training data with the noisy images helps improve performance by improving the model's ability to generalize and accurately classify new images.

For example, in one embodiment, a plurality of noisy images are used to train the classifier. Each noisy image of the one or more noisy images is generated by introducing noise into the distortion data to obtain noisy distortion data and then generating the noisy image through transforming the noisy distortion data into an image. This noise may be Additive White Gaussian Noise (AWGN) of different percentage of the voltage distortions (e.g., 1%, 2%, 3%, 4%, 5%, and 10%), or other noise that is or is expected to be similar or otherwise representative of noise experienced during use of the communication system whereby data transmission signals are sent.

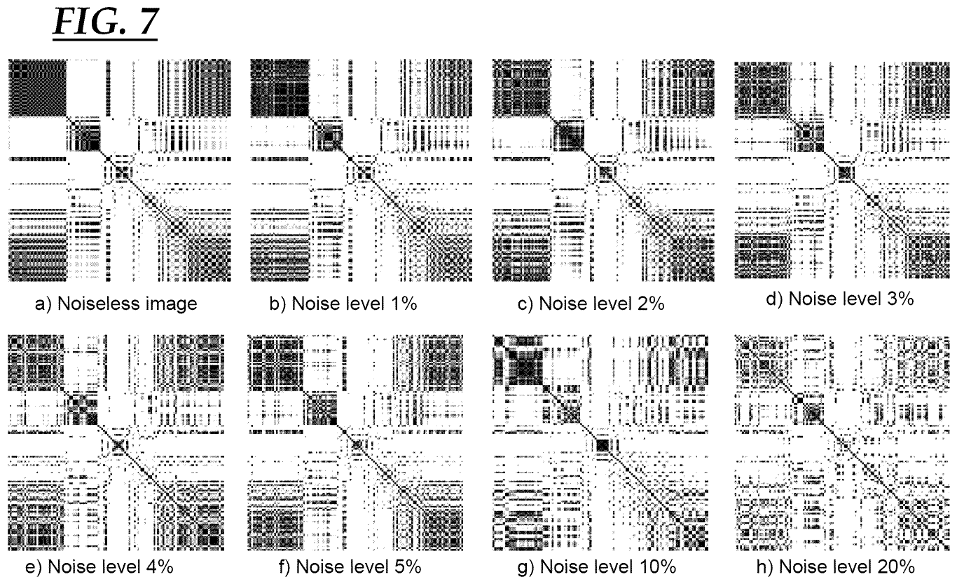

This subsection represents the analysis of the effect of environmental conditions on the performance of the proposed framework. It is important because, the foundation of the proposed methodology is image classification where the images are created from the distortions present in electrical signals and the signal characteristics are sensitive to environmental factors like temperature, amount of moisture contamination, aging, etc. These factors, if not accounted for, could lead to incorrect identification of the senders in real-world scenarios. In order to verify their effect, data is collected from a setup testbed with 8 ECUs and then analysis is performed to measure performance of the proposed framework under the presence of noise that may be produced by environmental factors. To add the noise, a simulation is created by adding Additive White Gaussian Noise (AWGN) of different percentage of the voltage distortions (1%, 2%, 3%, 4%, 5% & 10%) to the voltage signals. The overall experiment is divided into two different steps, first one is adding AWGN to the electrical signals and creating the images by using the noisy distortions. FIG. 7 shows the distorted images that are generated from different level of noisy voltages. In the subfigure (a) represents an image generated without AWGN, while subfigures (b), (c), (d), (e), (f), (g) represent images with 1%, 2%, 3%, 4%, 5% & 10% added AWGN, respectively. The noiseless and noisy figures clearly indicates that the noises caused by environmental factors has significant effect on the images generated by the voltage distortions while there is deviation from the original image increases with the addition of level of noises to the voltages.

In the second step of the experiment, a deep learning model is trained using the noiseless original noise, while the images with noise is tested against the trained model and the model performance is evaluated in terms of sender identification accuracy (shown in Table 4). While introducing 1% noise in the testing data the performance of the proposed framework degrades by a 30.23% so the proposed model is sensitive to environmental noise. To check the performance of the proposed approach when the model is retrained, again the trained model is retrained by adding images with 1% AWGN and tested against noisy images. Later the trained model was retrained with 2% noise and model performance against noisy images was evaluated again. According to experimental results, when the generated images with 1% AWGN are introduced during the model training with noiseless images, testing accuracy improves significantly for noisy images (1%, 2%, 3%, 4%, 5% and 10% GN). Although the training data had only noisy images with low AWGN (1%), the trained model was able to classify noisy images with an improvement of maximum 34.47% and minimum 19.37%. Again, when the model was again retrained by introducing noisy images with 2% AWGN and the model can identify senders with an maximum upgrade of 9.2% in terms of accuracy. So, it can be concluded that, the proposed framework is performs better if the model is retrained with noisy images.

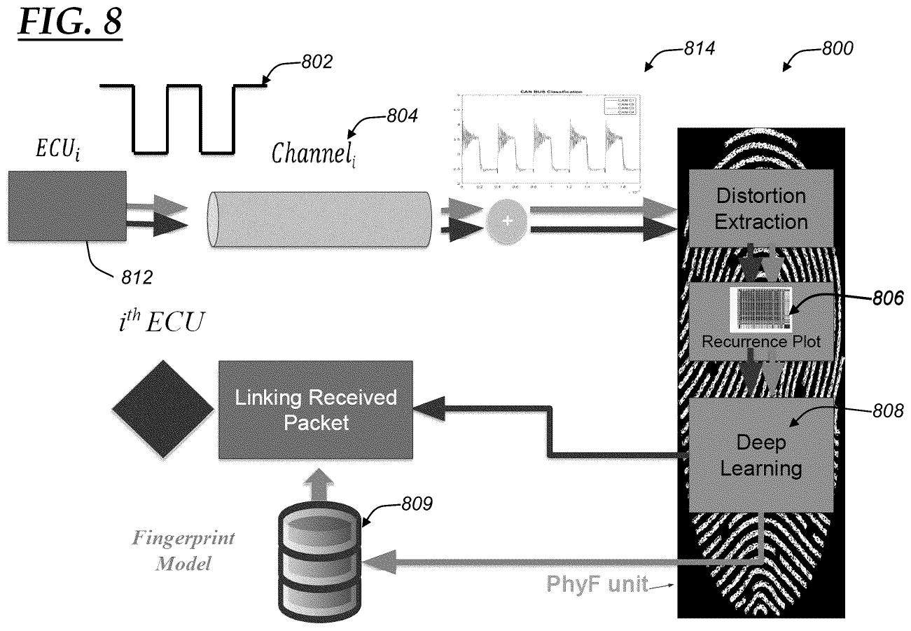

With reference to FIG. 8, there is shown an embodiment of a sender identification system 800 that implements the method 200, according to an embodiment. The sender identification system 800 includes a sender 812 that transmits a data transmission signal 802 over a physical channel 804, such as a CAN twisted pair. The data transmission signal 802 is received at a receiver 814, which then processes the data transmission signal using the method 200 in order to identify the sender 812. In the depicted embodiment, the data transmission signal is used to generate a recurrence plot 806, which is used as input into a deep learning classifier 808 that then generates classification data used to link the received data transmission signal to the sender 812. The fingerprint models generated based on data transmission signals from the set of potential ECUs/senders to be identified may be stored in a fingerprint data store 809, as shown in FIG. 8.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/of” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of determining an identity of a sender of a message, comprising:
obtaining distortion data of a data transmission signal sent by a sender over a physical channel through sampling the data transmission signal, wherein the distortion data represents extracted attributes of the data transmission signal as observed over the physical channel;
generating distortion image data that represents the distortion data as an image; and
identifying a sender of the data transmission signal based on an output generated by a classifier that takes the distortion image data as input.

2. The method of claim 1, wherein the image is a two-dimensional image represented by a matrix of data values each representing a pixel of the image.

3. The method of claim 1, wherein the image is a recurrence plot generated based on the distortion data.

4. The method of claim 3, wherein the distortion data is voltage time-series data.

5. The method of claim 4, wherein the recurrence plot is generated by:
comparing a recurrence threshold to a difference between a first voltage time-series data value and a second voltage time-series data value; and
determining a pixel value of the recurrence plot based on whether the difference exceeded the recurrence threshold.

6. The method of claim 1, wherein the classifier is or includes a convolutional neural network (CNN) that performs convolution operations on the image.

7. The method of claim 1, wherein the classifier is trained using noisy image training data, and wherein the noisy image training data includes one or more noisy images.

8. The method of claim 7, wherein each noisy image of the one or more noisy images is generated by introducing noise into the distortion data to obtain noisy distortion data and then generating the noisy image through transforming the noisy distortion data into an image.

9. The method of claim 8, wherein transforming the distortion data into an image is performed by generating a recurrence plot based on the noisy distortion data.

10. The method of claim 1, wherein the distortion data represents a difference between observed measurements in the data transmission signal and expected values.

11. The method of claim 1, wherein the extracted attributes of the data transmission signal are used for generating the distortion image data.

12. The method of claim 11, wherein the distortion image data includes at least one pixel value determined by: determining a voltage value for the data transmission signal, and comparing the voltage value for the data transmission signal to a target voltage.

13. The method of claim 12, wherein the target voltage is greater than 0.5 Volts and less than or equal to 5 Volts.

14. The method of claim 11, wherein the data transmission signal is formed as a series of voltage differentials relative to one or more predefined voltage levels, and wherein the target voltage is a voltage of one of the predefined voltage levels.

15. The method of claim 14, wherein each of the one or more predefined voltage levels is associated with a discrete state used for indicating a value of a message being communicated in accordance with the physical channel.

16. The method of claim 15, wherein the one or more predefined voltage levels is a plurality of predefined voltage levels, and wherein the target voltage is selected as one of the plurality of predefined voltage levels based on the discrete state.

17. The method of claim 16, wherein the discrete state corresponds either to a recessive state indicating a recessive bit as the value of the message being communicated or to a dominant state indicating a dominant bit as the value of the message being communicated.

18. An electronic control unit (ECU) authentication system for authenticating transmission signals carrying data over a communications network, comprising:
a first ECU having at least one processor and memory storing computer instructions;
a second ECU;
a communications network for providing a physical channel for carrying a data transmission signal from the second ECU to the first ECU;
wherein the ECU authentication system is configured, as a result of executing the computer instructions using the at least one processor, to:
obtain distortion data of a data transmission signal sent by the second ECU over the physical channel of the communications network, wherein the distortion data is obtained through sampling the data transmission signal;
generate distortion image data that represents the distortion data as an image; and
identify a sender of the data transmission signal based on an output generated by a classifier that takes the distortion image data as input.
